(19) United States
(12) Patent Application Publication
(10) Pub. No.: US 2016/0091005 A1
(43) Pub. Date: Mar. 31, 2016

(54) BEAM CLAMP

(71) Applicant: Hatton Marine and Industrial Repair, Inc., Seattle, WA (US)

(72) Inventor: Dustin Jones, Seattle, WA (US)

(21) Appl. No.: 14/496,693

(22) Filed: Sep. 25, 2014

(51) Int. Cl. F16B 2/18; F16B 2/10; F16M 13/02

(52) U.S. Cl. CPC F16B 2/185; F16M 13/022; F16B 2/10

(57) ABSTRACT

A beam clamp is formed with a pair of opposing plates having a central horizontal slot. A hook is pivotally attached between the plates such that a load can be attached to the hook. The hook further includes an upright that is configured to abut a vertical portion of an L-beam or similar structure. In use, a horizontal flange of an L-beam is received within the central horizontal slot while a vertical flange of the L-beam is retained by the upright.

### FIELD OF THE INVENTION

This invention generally relates to clamps, particularly including clamps for engaging beams and supporting a load by the beam.

### BACKGROUND OF THE INVENTION

In many situations, it is useful to suspend a load from a horizontal flange such as the bottom flange of an I-beam, an L-Beam, or a similar structure having an elongated flange. A variety of different types of adjustable beam clamps have been designed for this purpose. For example, U.S. Pat. No. 2,877,974 describes an adjustable beam clamp having a pair of opposing hooks joined together at their shanks in order to attach the clamp to the bottom flange of an I-beam. Similarly, some clamps such as a heavy duty beam clamp manufactured by JET tools are configured with opposing jaw members that may be augured to a closed position in order to mount to a flange of an I-beam.

Some prior clamps for engaging beams are configured essentially as an adjustable C-clamp, such as described in U.S. Pat. No. 5,934,655. In a clamp of this type, a pair of clamping arms are joined by a vertical upright. The clamp can be placed about a horizontal flange, with a threaded screw extending vertically through one of the clamping arms in order to tighten the clamp to the flange.

In general, the various clamps designed for suspension from beams tend to be complicated and difficult to attach, unnecessarily heavy and unwieldy, lacking in safety features to ensure retention to the beam, or unable to carry heavy loads.

### SUMMARY OF THE INVENTION

A beam clamp configured in accordance with a preferred version of the present invention includes a pair of opposing plates having a central horizontal slot. A hook is pivotally attached between the plates such that a load can be attached to the hook. The hook further includes an upright that is configured to abut a vertical portion of an L-beam or similar structure. In use, a horizontal flange of an L-beam is received within the central horizontal slot while a vertical flange of the L-beam is retained by the upright. In accordance with preferred versions of invention, each of the hook and the opposing plates are integrally formed from heavy gauge steel and are capable of carrying a substantial load.

### BRIEF DESCRIPTION OF THE DRAWINGS

Preferred and alternative examples of the present invention are described in detail below with reference to the following drawings. The drawings are further illustrated as a scale representation of a preferred version of the invention.

FIG. 1 is a top perspective view of a clamp configured in accordance with a preferred version of the invention.

FIG. 2 is a top perspective view of a pair of opposing plates for a clamp configured in accordance with FIG. 1, with the hook not shown.

FIG. 3 is a perspective view of the pair of opposing plates as illustrated in FIG. 2, shown with the plates rotated 180°.

FIG. 4 is a perspective view of a preferred hook.

FIG. 5 is a top plan view of a preferred clamp, shown with a hook pivoted into an open position.

FIG. 6 is a top plan view of a preferred clamp, shown with the hook pivoted into a closed position, and further illustrated as being attached to a flange of an L-beam.

### DETAILED DESCRIPTION OF THE PREFERRED EMBODIMENT

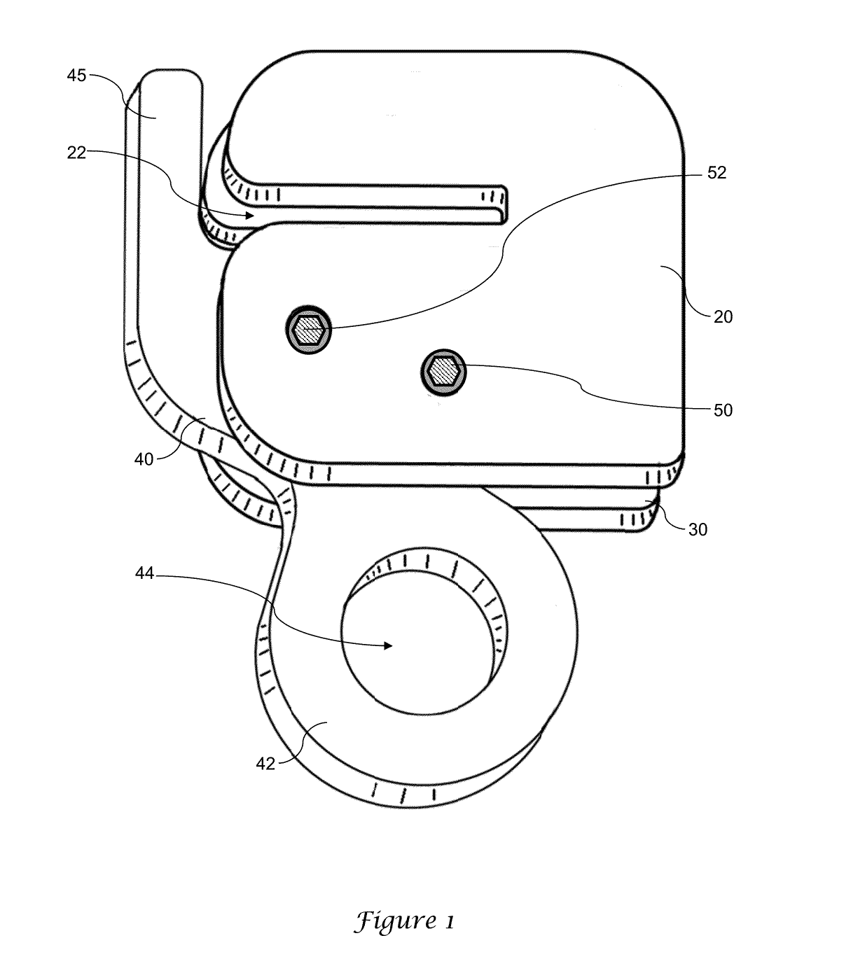

A preferred version of a beam clamp is illustrated in the accompanying figures in which reference numbers indicate common elements illustrated in the various figures. As illustrated in FIG. 1, a beam clamp includes a first plate 20 and a second plate 30 sandwiched around a hook 40. The hook 40 is pivotally attached between the first and second plates at a pivot point, which is located at an axis defined by a bolt 52 extending through each of the first and second plates and the hook 40.

In the illustrated version, each of the first and second plates 20, 30 is formed in a planar fashion. That is, each plate is manufactured from a section of flat steel and includes a planar inside service and a planar outside surface. While a planar configuration for the plates is illustrated and described in accordance with the preferred version of the invention, it should be understood that in other versions of the invention the plates need not be entirely planar. In a preferred version, each of the plates is formed from mild steel having a thickness of ½ inch; other versions may use thicker or thinner steel, or different materials, depending on the desired strength of the clamp and the load to be carried.

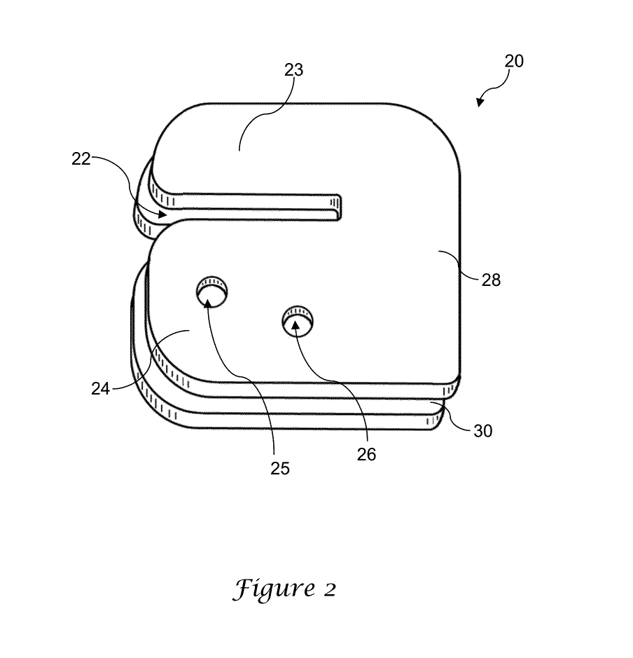

Each plate is formed generally as a C-shape, having a horizontal slot 22 extending from one side edge of the plate into an interior of the plate. As best seen in FIG. 2, the first plate includes an upper arm 23 and a lower arm 24 joined together by a vertical upright 28. In one preferred version, the upper arm 23 is configured to have a height (defined from the slot 22 to an upper edge) that is narrower than the height of the lower arm (from the slot 22 to a lower edge). In one example, the upper arm has a width of about 1.5 inches while the lower arm has a height of about 2.7 inches; in other examples of the invention the dimensions may vary.

The horizontal slot 22 separates the upper arm and the lower arm. In the illustrated version, the horizontal slot 22 is formed as a narrow elongated slot configured to receive a generally flat flange of the beam. In one preferred version, the slot is about ½ inch or less in height between the upper arm and the lower arm, and more preferably is about 0.425 inches in height. The slot may alternatively have a different height as desired in order to accommodate flanges of different thicknesses. In one preferred version the slot further has a length of about 3 inches or less from the opening of the slot at one side edge to a termination point at the interior of the plates. In one preferred version the slot has a length of 2.8 inches. In other versions, the slot may have longer or shorter lengths in order to accommodate flanges having particular dimensions.

Each of the first and second plates further includes a pair of holes 25, 26 extending through the plates. As described above, the first hole 25 is configured to receive a bolt to find a pivot plane for pivotal attachment of the hook to the plates. A second hole 26 is configured to receive a lock, preferably configured as a removable bolt, configured to lock the hook against pivotal movement into an open position. While the holes 25, 26 of the first plate are shown, the complementary holes in the second plate 30 are in the same locations but not visible as illustrated.

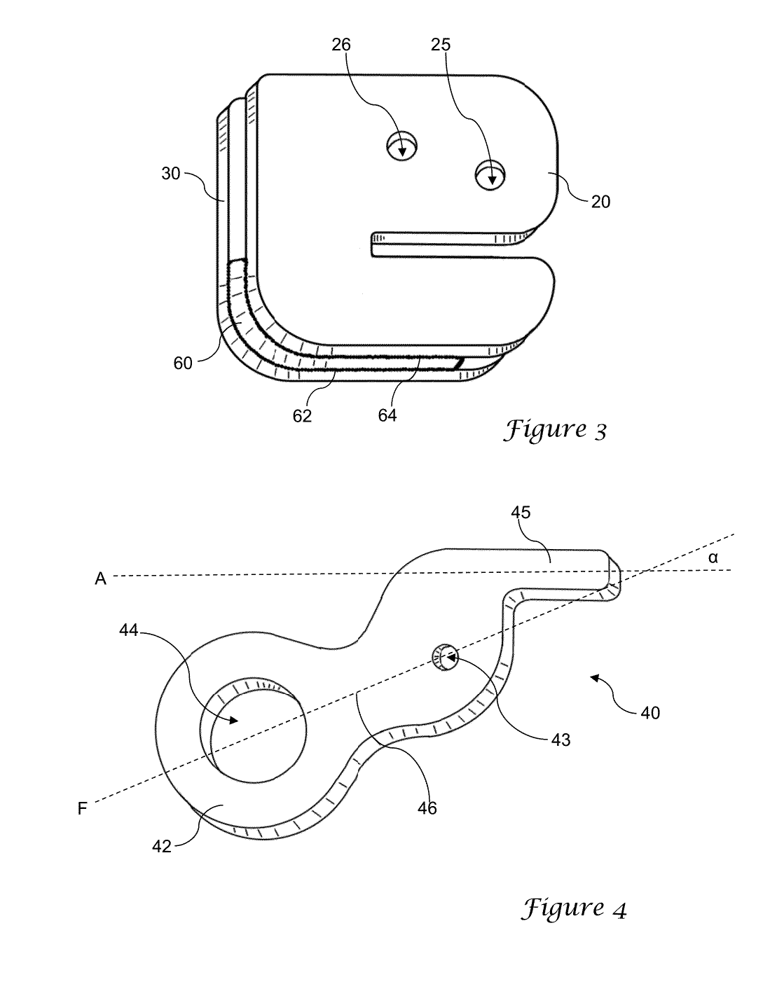

As best seen in FIG. 3 in which the plates are rotated 180°, the first and second plates are joined together by a latch 60. In the illustrated version, the latch 60 is formed as a J shape and is joined to the upper arm of each of the two plates 20, 30 along an upper edge of the plates and partially at the back edge of the plates opposite the channel 22. In a preferred version, the latch 60 is welded to each of the first and second plates along weld lines 62, 64. In other versions of the invention, the latch may be otherwise attached to the first and second plates. In yet other versions, the first and second plates may be bolted together in substantially the same location, with a spacer placed between the first and second plates in order to provide separation to allow for pivotal movement of the hook. The welded version of the latch as illustrated and described is preferred because it provides improved strength and rigidity. In the preferred version of the invention, the first and second plates are fully spaced apart from one another and are open along the boundaries of the plates other than at the location of the latch as illustrated in FIG. 3.

A preferred hook in accordance with the invention includes a lower portion 42, which in the illustrated version is configured as a ring having a central opening 44. The ring may be dimensioned as desired, and in one version the central opening is approximately 2 inches in diameter and is configured to allow it to receive a hook, carabiner, chain, rope, or other attachment mechanism in order to carry or support a load from the lower portion 42. An upper portion 45 of the hook is configured as an upright, preferably formed as an elongated extension as illustrated.

A hole 43 is formed in a central portion of the hook and is configured to support the hook for pivotal rotation within the space between the first and second plates 20, 30. Thus, the bolt 52 extends through the first plate 20, the hole 43 in the hook 40, and the second plate 30 when the clamp is assembled. A central portion of the hook includes a scalloped waist 46 shaped to interact with a second bolt 50, which locks the hook against rotational movement as described below.

The upright 45 extends generally along a plane A as illustrated in FIG. 4. In FIG. 4, plane F is defined as extending through the center of the hole 43 and the central opening 44 and the lower portion of the hook. In a version of the invention in which the lower portion is configured as an open hook rather than an enclosed ring, the plane F is defined as extending through substantially the same location within such a hook. Plane A and plane F are non-parallel to one another, defining an angle α between planes A and F. As described more fully below, this angularly offset arrangement between the lower portion, the pivot plane 43, and the upright allows for the load to be carried in a way that urges the upright against the vertical portion of an L beam and thereby uses the load to help secure the clamp to the beam.

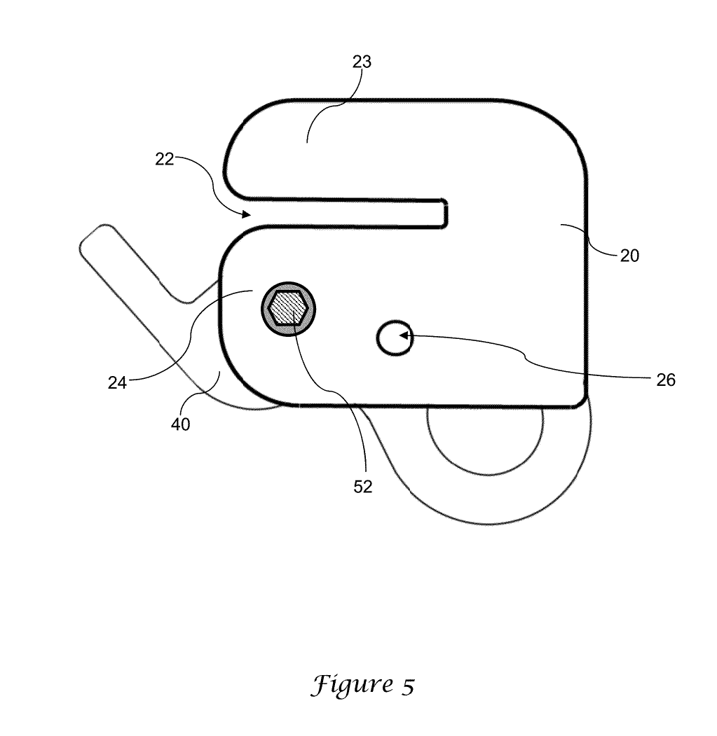

With reference to FIG. 5, a top plan view shows a first plate 20 attached to the hook 40, with the second plate not visible beneath the first plate and the hook. The elongated slot 22 just beneath the upper arm 23 is accessible by a flange of an L beam because the hook 40 is pivoted into a first open position. As shown, the hook is mounted to the clamp by the first bolt 52 but the second bolt 50 (not shown in FIG. 5) which would extend through the hole 26, is removed. The removal of the second bolt allows the hook to be pivoted to the open position; if the second bolt were in place within the hole 26 then it would impede movement of the hook to the open position as illustrated in FIG. 5.

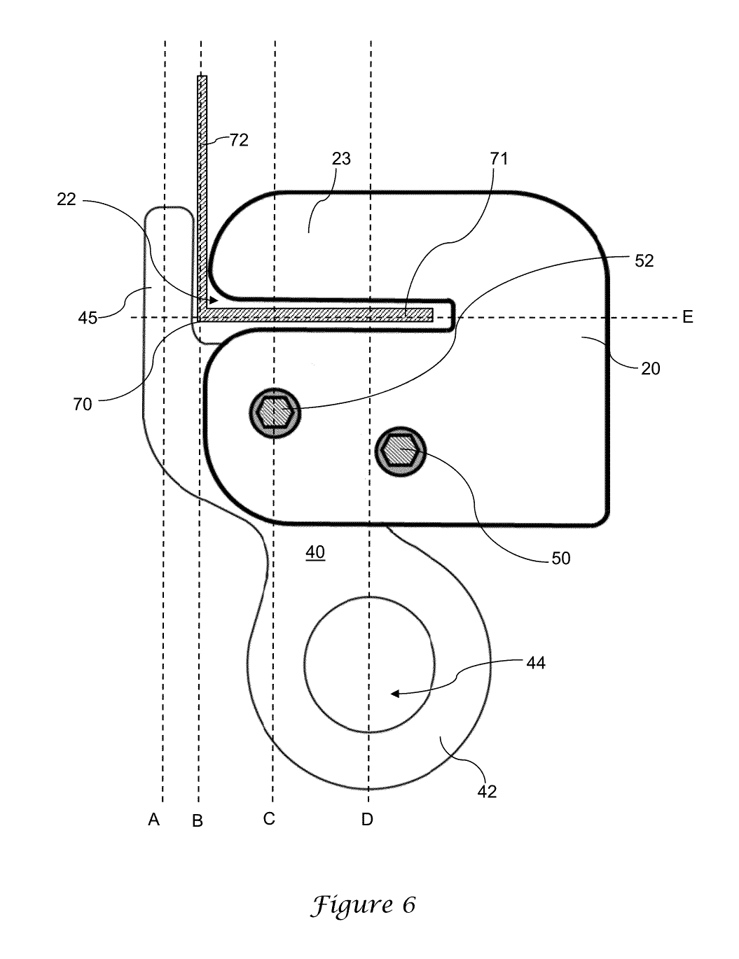

With reference to FIG. 6, the top plan view shows the clamp mounted to an L-beam 70 and with the hook in a second closed position. As shown, only an end or sectional view of the L-beam 70 is visible. In the illustrated version, the L-beam 70 includes a vertical upright portion 72 and a horizontal flange 71. The horizontal flange 71 is received within the elongated slot 22 of the first and second plates. In order to insert the horizontal flange 71 into the elongated slot 22, the second bolt 50 is removed to enable the hook 40 to be pivoted to the first position as illustrated in FIG. 5. Once the clamp is positioned on a horizontal flange 71 the hook 40 may be pivoted to the second position as illustrated in FIG. 6. Once in this position, the second bolt 50 may be inserted through the second holes formed in both the first and second plates. The second bolt 50, when mounted on the first and second plates, will abut or be closely adjacent to the scalloped waist 46 of the hook 40, thereby preventing pivotal movement of the hook from the second position as illustrated in FIG. 6 to the first position as illustrated in FIG. 5.

When the clamp is mounted to a beam as illustrated in FIG. 6, the configuration of the various components and the location of the pivot point for the clamp allow the clamp to carry a load while being securely retained on the beam. The upright portion 45 of the hook extends along a plane A which is preferably generally parallel to a plane B defined by the vertical portion 72 of the beam. In this manner, the upright portion 45 of the hook can engage the vertical portion 72 of the beam, sandwiching the vertical portion of the beam between the upright portion 45 of the hook and the upper arm of each of the first and second plates.

The pivot axis for the hook, co-located at the bolt 52, is offset from both plane A and plane B, and lies in plane C. In addition, a further plane D is farther offset from plane A which defines the upright portion 45. In general, plane D extends vertically through the center of gravity of the lower portion 42 of the hook when a load is carried by the hook. As best seen in FIG. 6, the plane D extending through the center of gravity of the lower portion of the hook is positioned on one side of the pivot plane (at bolt 52) while the planes A and B extending through the upright portion 45 and the vertical portion 72 of the beam are each located on the opposite second side of the pivot plane.

Similarly, plane E is defined as extending through the elongated slot 22, and as best seen in FIG. 6, plane E is parallel to the center of the slot and also to the flange 71 extending into the slot. Each of the axes A-D are defined to be perpendicular to plane E. Thus, Plane C extends through the bolt 52 and is perpendicular to the slot plane E. When the hook is pivoted to the closed position, the bottom of the lower portion 42 of the hook and the upright portion 45 each lie on opposite sides of plane C.

Because of this configuration of the locations of the lower portion 42 and the upright portion 45 with respect to the pivot plane formed in the hook 40, when the load is carried on the lower portion of the hook, it will urge a rotational force about the pivot plane, in a clockwise direction as seen in FIG. 6, thereby urging the upright portion 45 against the vertical portion 72 of the beam. This offset configuration and rotational force imparted by the load will further sandwich the beam within the clamp, holding the clamp securely against the beam.

For added safety, the second bolt 50 is inserted through the first and second plates when the clamp is mounted to a beam, preventing rotational movement of the hook 40 into the open position and thereby locking the clamp to the beam. The offset configuration of the hook 40, as described above, further provides a force to retain the hook in the second closed position, which in many cases may make the use of the second bolt 50 unnecessary.

The clamp is generally described above as being configured for attachment to an L-beam, and FIG. 6 illustrates a preferred clamp attached to such a beam. It should be appreciated that the same clamp may also be attached to flanges or similar features extending from other structures besides L-beams. Further, it should be appreciated that the clamp can be attached to such flanges extending in orientations other than horizontal as shown and described.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A beam clamp, comprising:
a first plate;
an opposing second plate secured to the first plate to define an open space between the first plate and the second plate, each of the first plate and the second plate having an upper arm, a lower arm, and an elongated slot positioned between the upper arm and the lower arm, the elongated slots of the first plate and the second plate being aligned with one another for receiving a flange within the elongated slots, the elongate slots further defining a first plane extending through the elongated slots;
a hook carried in the open space between the first plate and the second plate, the hook having an upright portion, a central portion, and a lower portion configured for attachment to a load, the hook being pivotally mounted to the first plate at a pivot location formed in the central portion of the hook, the pivot location further lying on a second plane orthogonal to the first plane,
the hook further being pivotally movable between a first open position for receiving the flange and a second closed position for securing the clamp to the flange;
the upright portion of the hook and a bottom of the lower portion of the hook being positioned on opposite sides of the second plane when the hook is in the second closed position.

2. The beam clamp of claim 1, wherein the lower portion of the hook comprises an enclosed ring.

3. The beam clamp of claim 1, wherein each of the first plate and the second plate are formed with a first side and a second side, each of the first side and the second side being planar.

4. The beam clamp of claim 1 wherein the upper arm has an upper arm height from the elongated slot to an upper edge of the first and second plates and the lower arm has a lower arm height from the elongated slot to a lower edge of the first and second plates, the lower arm height being greater than the upper arm height.

5. The beam clamp of claim 1, wherein the hook is pivotally mounted to the first plate and the second plate via a first bolt extending through the first plate, the hook, and the second plate.

6. The beam clamp of claim 5, further comprising a lock extending between the first plate and the second plate to restrict the hook against rotational movement from the second position to the first position.

7. The beam clamp of claim 6, wherein the lock comprises a bolt attached to the clamp.

8. The beam clamp of claim 6, wherein the lock comprises a bolt removably extending through the first plate and the second plate.

9. The beam clamp of claim 6, wherein the lock is positioned on the same side of the second plane as the bottom portion of the hook.

10. The beam clamp of claim 6, wherein the central portion of the hook further comprises a scalloped waist configured to engage the lock.

11. The beam clamp of claim 1, further comprising a latch attached the upper arm of the first plate and the second plate, the latch being configured to define the open space between the first plate and the second plate, wherein the perimeter of the first plate and the second plate is open other than at the location of the latch.

12. The beam clamp of claim 1, wherein the flange is a horizontal flange of an L-beam, and further wherein a vertical portion of the L-beam is retained between the upright portion of the hook and the upper arms of the first and second plates when the hook is pivoted in the closed position.

13. A beam clamp, comprising:
a first plate;
a second plate;
the first plate being secured to and spaced apart from the second plate to define an open space between the first plate and the second plate, each of the first plate and the second plate having an upper arm, a lower arm, and an elongated slot positioned between the upper arm and the lower arm, the open space further being open along the perimeter of the lower arm, the elongated slots of the first plate and the second plate further defining a first plane extending through both of the elongated slots; and
a hook having an upright portion, a central portion, and a lower portion configured for attachment to a load, the hook being positioned within the open space between the first plate and the second plate and pivotally mounted to the lower arm at a pivot location formed in the central portion of the hook, the pivot location further being positioned on a second plane orthogonal to the first plane, whereby the hook is pivotally movable between a first open position in which the upright portion is pivoted away from the upper arm and a second closed position in which the upright portion is pivoted adjacent the upper arm;
the upright portion of the hook and the lower portion of the hook further being positioned substantially on opposite sides of the second plane when the hook is in the second closed position.

14. The beam clamp of claim 13, wherein the lower portion of the hook comprises an enclosed ring.

15. The beam clamp of claim 13, wherein each of the first plate and the second plate are planar.

16. The beam clamp of claim 13, wherein the hook is pivotally mounted to the first plate and the second plate via a first bolt extending through the first plate, the hook, and the second plate.

17. The beam clamp of claim 13, further comprising a lock extending between the first plate and the second plate to restrict the hook against rotational movement from the second position to the first position.

18. The beam clamp of claim 17, wherein the lock comprises a bolt removably extending through the first plate and the second plate.

19. The beam clamp of claim 18, wherein the lock is positioned on the same side of the second plane as the bottom portion of the hook.
